(19) United States
(12) Patent Application Publication
(10) Pub. No.: US 2012/0147585 A1
(43) Pub. Date: Jun. 14, 2012

(54) Telescopic Light Pole System

(76) Inventor: John F. Girouard, East Haddam, CT (US)

(21) Appl. No.: 12/963,915

(22) Filed: Dec. 9, 2010

(51) Int. Cl. F21V 9/16

(52) U.S. Cl. 362/84

(57) ABSTRACT

A telescopic light pole system includes a handle assembly having a tubular grab handle with at least one handle insert composed of a photoluminescent material mounted thereon. At least one mounting bracket mounts the handle assembly to a vehicle. A tubular extension member extends through the grab handle bore. A clamp collar assembly mounted to the handle assembly selectively locks the extension member to the handle assembly. A light fixture mounting member affixed to a first end of the extension member is adapted to mount a light fixture to the extension member. A power line receptacle is affixed to the second end of the extension member.

### BACKGROUND

This disclosure relates generally to telescopic pole systems. More particularly, this disclosure relates to telescopic pole systems for use with light standards.

When working in a dark work area, it is often desirable to illuminate the work area. In a conventional work area, such as a construction site, this can be easily accommodated by placing several worklights at different locations within the work area. Temporary power lines may be run throughout the work area to provide power to the worklights.

However, when the work area is the site of an emergency such as a fire, accident, or the like, there may be no power source to provide power to the worklights or it may not be possible to run temporary power lines. An initial solution to this problem was to mount area lighting fixtures to emergency vehicles and to use these lighting fixtures to illuminate the site of the emergency. However, the relatively low height of the lighting fixtures and the fact that the lighting fixtures were fixedly mounted in place limited their usefulness. Subsequently, telescopic pole systems have been used to mount the area lighting fixtures to the emergency vehicle. By vertically extending the pole system, the lighting fixture may be positioned at a height well above the emergency vehicles and emergency personnel that might otherwise obstruct the light. The poly system generally also allowed the extended pole to be rotated to some degree, thereby providing some ability to aim the light emitted by the lighting fixture.

### SUMMARY

There is provided a telescopic light pole system comprising a handle assembly including a tubular grab handle having at least one handle insert composed of a photoluminescent material mounted thereon. At least one mounting bracket mounts the handle assembly to a vehicle. A tubular extension member extends through the grab handle bore. A clamp collar assembly mounted to the handle assembly selectively locks the extension member to the handle assembly. A light fixture mounting member affixed to a first end of the extension member is adapted to mount a light fixture to the extension member. A power line receptacle is affixed to the second end of the extension member.

The grab handle has an outer surface with multiple longitudinally extending channels, with one of the handle inserts disposed within each of the channels.

Each of the grab handle channels extends from one end of the grab handle to the other end of the grab handle and includes a pair of recesses extending laterally from a central opening. Each handle insert includes a pair of wings extending laterally from a central body. The handle insert central body is disposed within the grab handle channel and the handle insert wings are disposed within grab handle channel recesses.

The handle assembly also includes an end cap and the clamp collar assembly includes a collar base. The clamp collar assembly collar base is mounted to one end of the grab handle and the handle assembly end cap is mounted to the other end of the grab handle to lock the handle inserts within the grab handle channels.

The photoluminescent material of the handle insert has a glow life of at least twelve hours.

The light fixture mounting member includes a cylindrical shaft portion mounted to the extension member first end and a mounting portion extend orthogonally from the shaft portion to a front face adapted for engaging a light fixture.

The light fixture mounting member mounting portion includes a back wall and a tubular sleeve extending from the back wall. The tubular sleeve has a bore that is substantially coaxial with an opening extending through the back wall. The sleeve bore and the back wall opening are adapted to receive a bolt for mounting a light fixture to the mounting portion.

The power line receptacle has a substantially cylindrical sidewall having outer and inner surfaces, a bore extending longitudinally from a bottom end and at least one opening extending laterally through the sidewall.

The telescopic light pole system may further comprise a support bracket including a mounting bracket having a pod assembly for mounting to the vehicle, and a bracket extending from the pod assembly. The bracket has a receptacle for receiving the power line receptacle bottom end. A power line receptacle sensor mounted to the bracket senses when the power line receptacle bottom end has been received within the bracket receptacle.

The power line receptacle sensor may be a Hall Effect sensor.

The support bracket also includes a sensor mount mounting the Hall Effect sensor to the mounting bracket. The sensor mount includes a base segment mounted to the bracket receptacle, and a platform segment extending upwardly from the base segment into a lower end portion of a bracket receptacle opening. The platform segment has an upper surface to support the power line receptacle bottom end.

The sensor mount platform segment includes a housing projecting upwardly from the upper surface, the housing is positioned within a bore in the power line receptacle when the power line receptacle bottom end is supported on the sensor mount platform segment upper surface. The Hall Effect sensor is disposed within the housing of the sensor mount platform segment.

The power line receptacle bottom end may include a magnetic material.

The telescopic light pole system may further comprise a pole status system including a pole status indicator and a controller in communication with the power line receptacle sensor and the status indicator.

The mounting bracket comprises a pod assembly and a bracket. The pod assembly includes a flange segment adapted to mount to the vehicle and a clamp segment extending from the flange segment to a distal end. The clamp segment has a channel extending from an opening in the distal end. The bracket includes an extension portion having distal and proximal ends. The proximal end segment of the extension portion is slidably disposed within the clamp segment channel. A receptacle portion is disposed at the extension portion distal end. The receptacle portion has an opening for receiving the handle assembly. A bracket locking device to lock the bracket extension portion to the pod assembly.

The bracket extension portion includes an upper surface having index marks.

### BRIEF DESCRIPTION OF THE DRAWINGS

The present disclosure may be better understood and its numerous objects and advantages will become apparent to those skilled in the art by reference to the accompanying drawings in which:

FIG. 1 is a perspective view of a telescopic light pole system in accordance with the disclosure;

FIG. 2 is an enlarged view of Area A of FIG. 1;

FIG. 3 is an enlarged view of Area B of FIG. 1;

FIG. 4 is an exploded view of the lock assembly and handle assembly of FIG. 1;

FIG. 5 is an enlarged exploded view of the lock assembly of FIG. 4;

FIG. 6 is a side view of the clamping element of FIG. 4;

FIG. 7 is a perspective view of the mounting element of FIG. 4;

FIG. 8 is an enlarged side view of the grab handle of FIG. 4;

FIG. 9 is an enlarged side view of the grip members of FIG. 4;

FIG. 10 is an enlarged exploded view of the handle assembly of FIG. 4;

FIG. 11 is an enlarged bottom view of the mount assembly of FIG. 1;

FIG. 12 is a top view of the mount assembly of FIG. 11;

FIG. 13 is a perspective view of the mount assembly of FIG. 11;

FIG. 14 is an exploded view of the mount assembly of FIG. 11;

FIG. 15 is an exploded view of the support bracket of FIG. 1;

FIG. 16 is an enlarged side view of the support bracket of FIG. 15; and

FIG. 17 is a cross-sectional view taken along line 1-1 of FIG. 15.

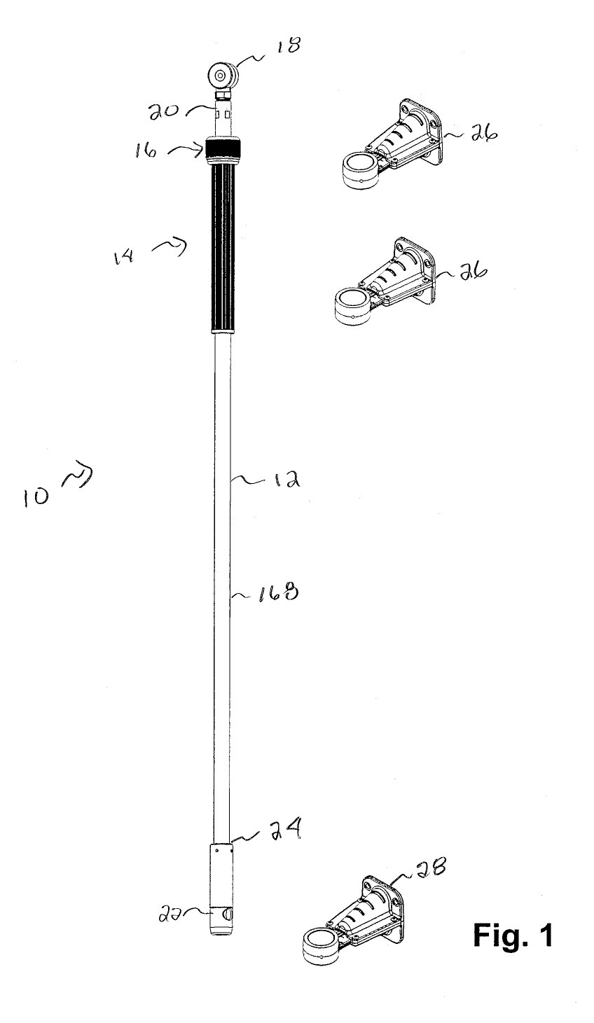

### DETAILED DESCRIPTION

With reference to the drawings wherein like numerals represent like parts throughout the several figures, a telescopic light pole system in accordance with the present disclosure is generally designated by the numeral 10. The light pole system 10 includes a tubular extension member 12, a handle assembly 14, a clamp collar assembly 16 to lock the extension member 12 to the handle assembly 14, a light fixture mounting member 18 affixed to the upper end 20 of the extension member 12, and a power line receptacle 22 affixed to the lower end 24 of the extension member 12. One or more offset mounting brackets 26 are used to mount the handle assembly 14 to a vehicle (not shown). A support bracket 28 may be used to support the lower end 24 of the extension member 12 when the extension member 12 is fully withdrawn, in a stored position.

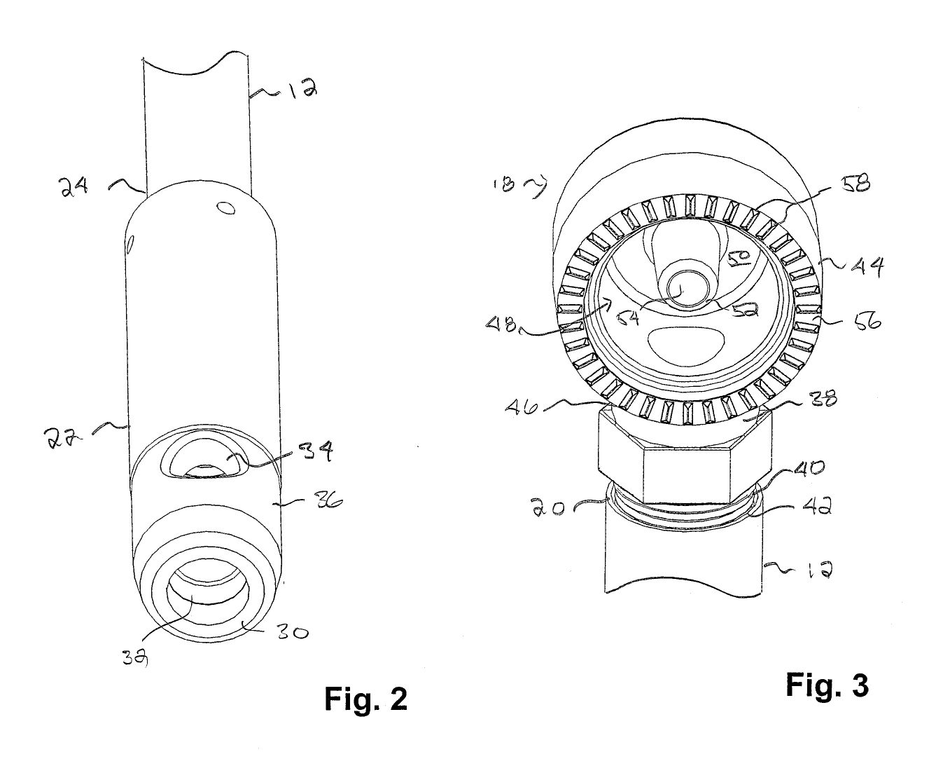

With reference to FIG. 2, the power line receptacle 22 is a cylinder having a beveled bottom end 30 having an axial opening 32 through which a power line (not shown) may be inserted through the extension member 12 to the light fixture mounting member 18. The power line receptacle 22 may also include one or more openings 34 that extend laterally through the sidewall 36 of the receptacle for receiving a power line.

With reference to FIG. 3, the light fixture mounting member 18 includes a cylindrical, downwardly extending shaft portion 38 having a threaded outer surface 40 at the lower end of the shaft portion 38. The upper end 20 of the extension member 12 has a threaded inner surface 42 that engages the shaft portion thread 40 to mount the light fixture mounting member 18 to the extension member 12. A mounting portion 44 extends orthogonally from the upper end 46 of the shaft portion 38. An annular cavity 48 in the mounting portion 44 defines a back wall 50 and a tubular sleeve 52 extending forward from the back wall 50, the inner bore 54 of the sleeve being coaxial with an opening extending through the back wall 50. A bolt (not shown) may be inserted through the back wall opening and the sleeve bore 54 to mount a lighting fixture (not shown) to the light fixture mounting member 18. The front face 56 of the mounting portion 44 may include serrations 58 adapted to engage a serrated surface of the light fixture.

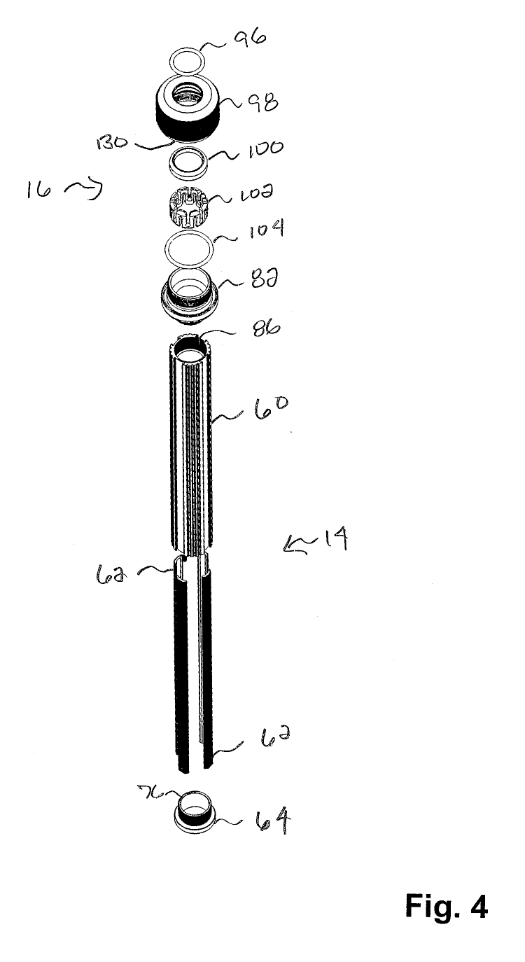

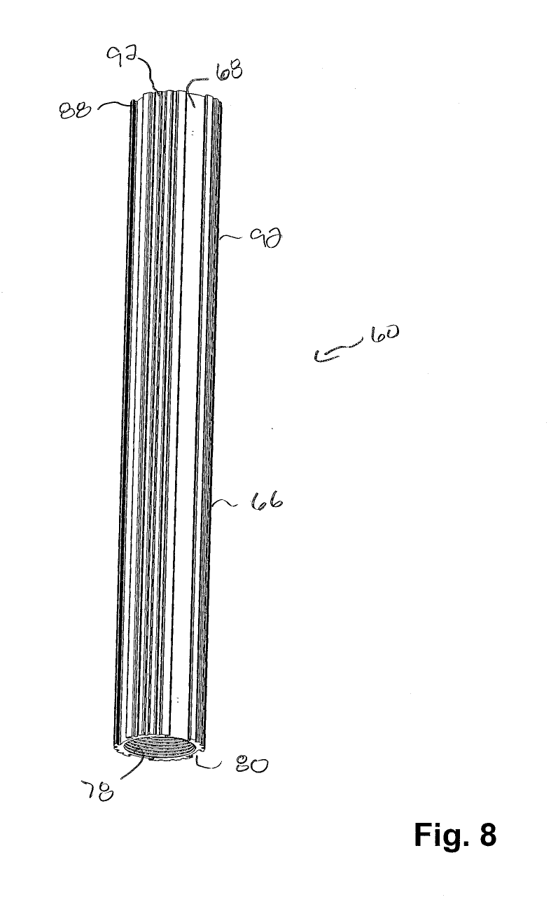

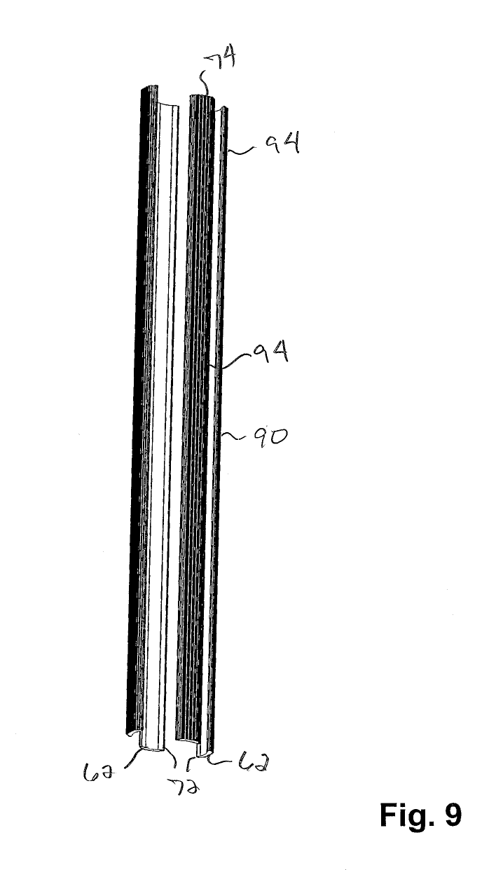

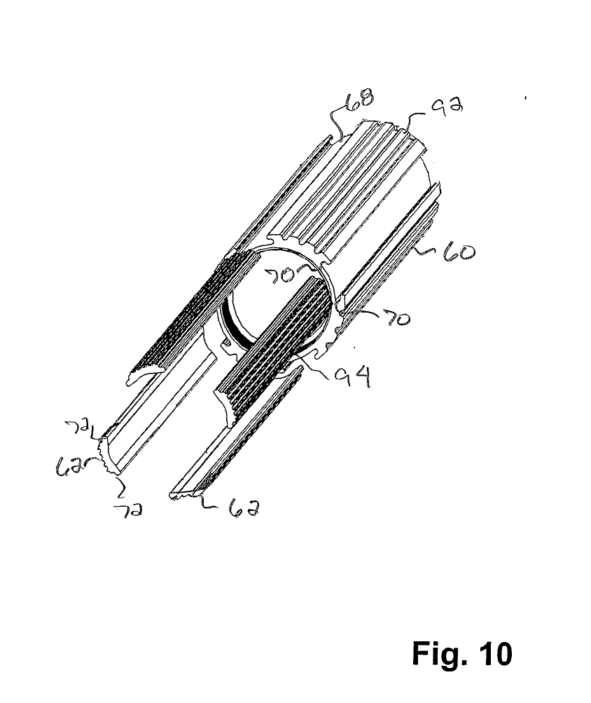

With reference to FIGS. 4 and 8-10, the handle assembly 14 includes a tubular grab handle 60, multiple handle inserts 62 and a lower end cap 64. The outer surface 66 of the grab handle 60 has multiple longitudinally extending channels 68, with each of the channels 68 including a pair of laterally extending recesses 70. Each handle insert 62 includes a pair of wings 72 that extend laterally from the sides of the central body 74. As shown in FIG. 10, each handle insert 62 is inserted into one of the channels 68 from one end of the grab handle 60, with the wings 72 being received within the recesses 70. The handle inserts 62 are locked to the grab handle 60 by the end cap 64, that has an upper segment 76 that is threadably connected to the threaded inner surface 78 of the lower end 80 of the grab handle 60, and the clamp collar assembly collar base 82, which has a lower segment 84 that is threadably connected to the threaded inner surface 86 of the upper end 88 of the grab handle 60. The outer surface 66 of the grab handle 60 and the outer surface 90 of each handle insert 62 includes multiple longitudinally extending ridges 92, 94 to facilitate gripping the handle assembly 14.

The handle inserts 62 are composed of a photoluminescent material, such as Chroma Glow™ produced by Chroma Corporation, McHenry, Ill., which has a glow life of thirty two (32) hours. It should be appreciated that the handle inserts 62 facilitate locating the handle assembly 14, the clamp collar assembly 16, and the light pole system 10 in general between the period of sundown and dawn.

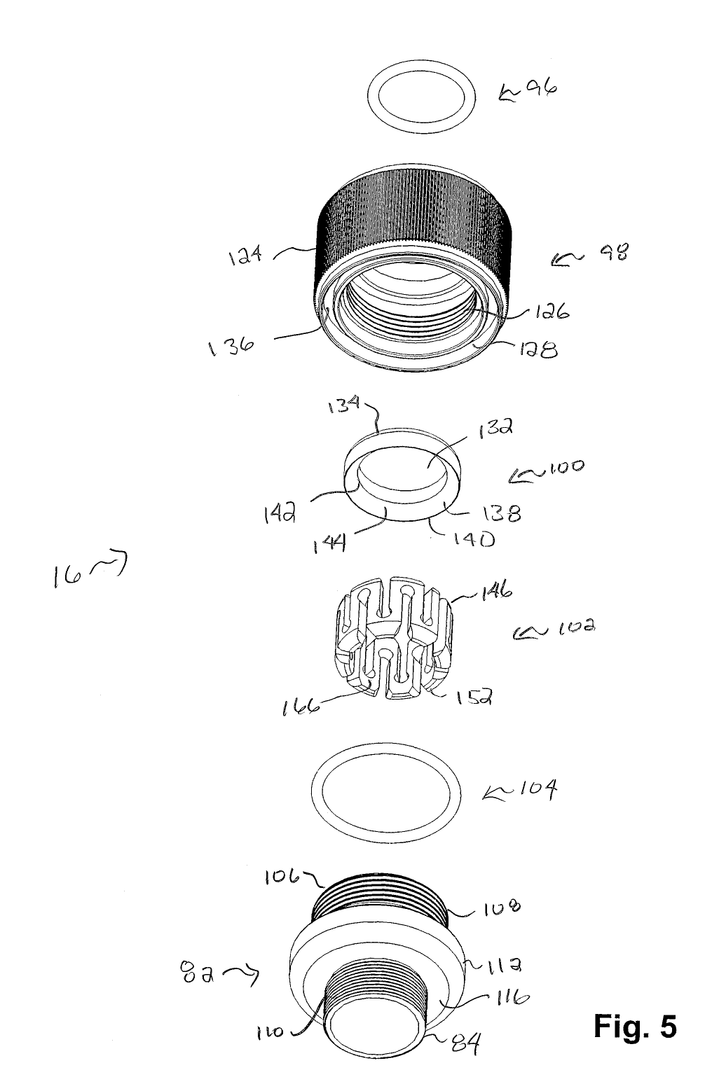

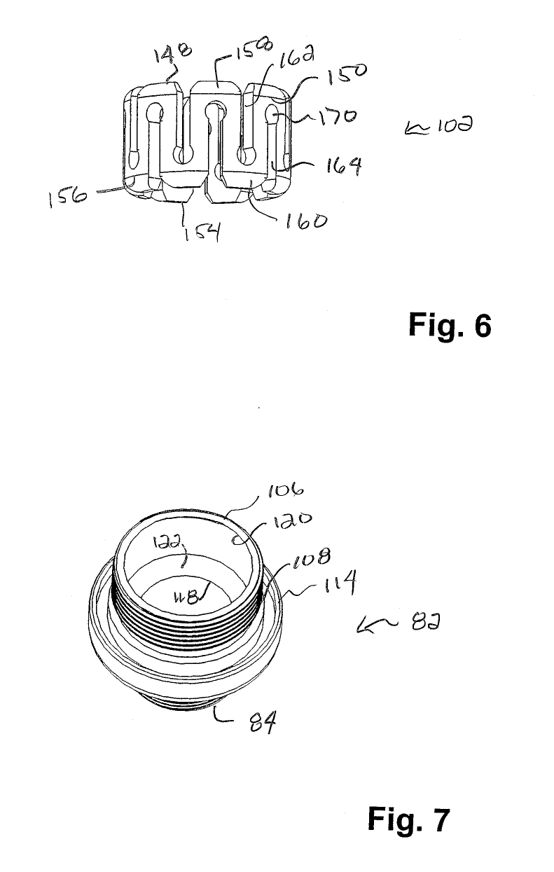

With reference to FIGS. 4-7, the clamp collar assembly 16 includes an upper end cap 96, a clamp collar 98, a shim insert 100, a clamp collet 102, an O-ring 104 and a collar base 82. The collar base 82 is a cylinder having upper and lower segments 106, 84, each of which have a threaded outer surface 108, 110. An outer mid segment 112 disposed intermediate the upper and lower segments 106, 84 extends radially outward to define upper and lower shoulders 114, 116. An inner mid segment 118 extends radially inward and downward from the inner surface 120 of the upper segment 106 to define a lower cam surface 122. The clamp collar 98 is a cylinder having a knurled outer surface 124, a threaded inner surface 126, and an annular recess 128 in the lower end 130. The threaded inner surface 126 of the clamp collar 98 threadably engages the threaded outer surface 108 of the collar base upper segment 106. The O-ring 104 is disposed between the upper shoulder 114 of the collar base 82 and the lower end 130 of the clamp collar 98. The knurled outer surface 124 facilitates applying a torque between the clamp collar 98 and the collar base 82 to compress the clamp collet 102, as explained in greater detail below.

The circular shim insert 100 is disposed within the recess 128 in the clamp collar's lower end 130, with an inner opening 132 of the shim insert 100 being substantially coaxial with the bores of the clamp collar 98 and the collar base 82. An upper surface 134 of the shim insert 100 is in contact with the upper surface 136 of the recess 128. A lower surface 138 of the shim insert 100 slopes upwardly from the outer bottom edge 140 of the shim insert 100 to inner bottom edge 142 to define an upper cam surface 144. The upper end 146 of the clamp collet 102 extends downwardly from the inner upper edge 148 to the outer upper edge 150 and the lower end 152 of the clamp collet 102 extends upwardly from the inner lower edge 154 to the outer lower edge 156 to define upper and lower follower surfaces 158,160.

The clamp collar assembly 16 locks the extension member 12 in position after the extension member 12 has been extended to a working position. The clamp collar assembly 16 may also be used to lock the extension member 12 in position when the extension member 12 is fully withdrawn in the stored position, to prevent movement of the extension member 12.

Rotating the clamp collar 98 relative to the collar base 82 causes the clamp collar 98 to move toward or away from the collar base 82 as threads 126 move along threads 108. Specifically, rotating the clamp collar 98 clockwise, when viewed from the top, causes the clamp collar 98 to move toward the collar base 82, biasing the upper follower surface 158 into engagement with upper cam surface 144 and the lower follower surface 160 into engagement with lower cam surface 122. Applying torque to further turn the clamp collar 98 clockwise pushes the upper and lower follower surfaces 158, 160 towards each other and also causes the upper and lower cam surfaces 144, 122 slide up the upper and lower follower 158, 160 surfaces. Upper notches 162, extending from the upper end 146 to a position intermediate the upper and lower ends 146, 152, and lower notches 164, extending from the lower end 152 to a position intermediate the upper and lower ends 146, 152, allow the clamp collet 102 to be compressed axially inward toward the extension member 12, whereby the inner surface 166 of the clamp collet 102 engages the outer surface 168 of the extension member 12 and thereby lock the extension member 12 in position. Circular openings 170 at the inner ends of the notches 162, 164 may be used to further facilitate compression of the clamp collet 102.

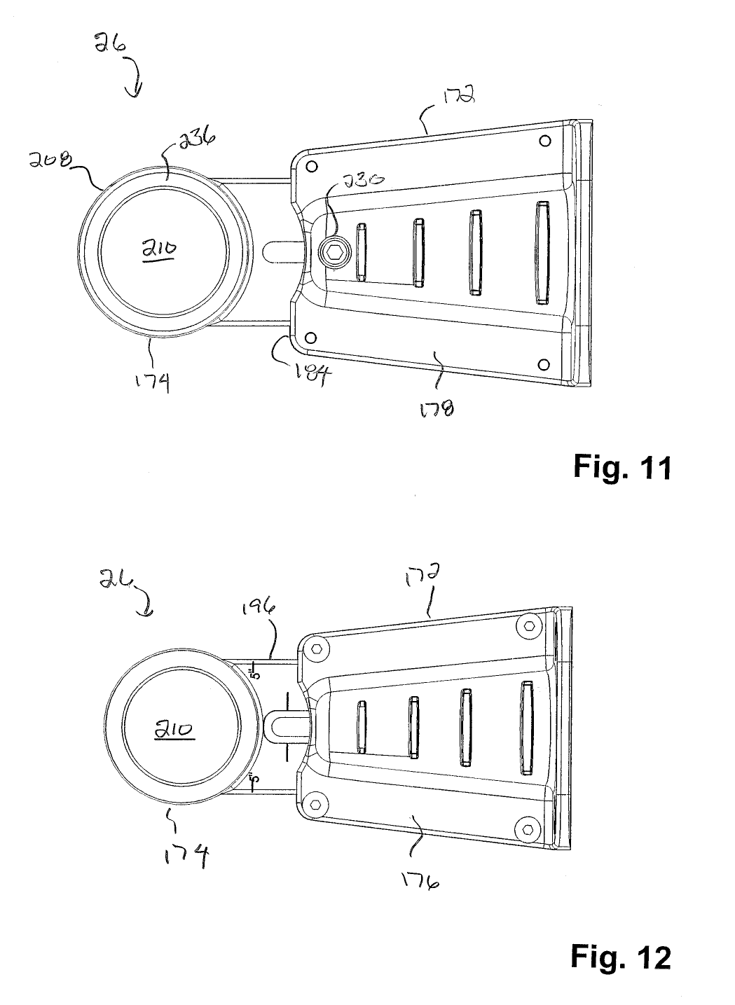

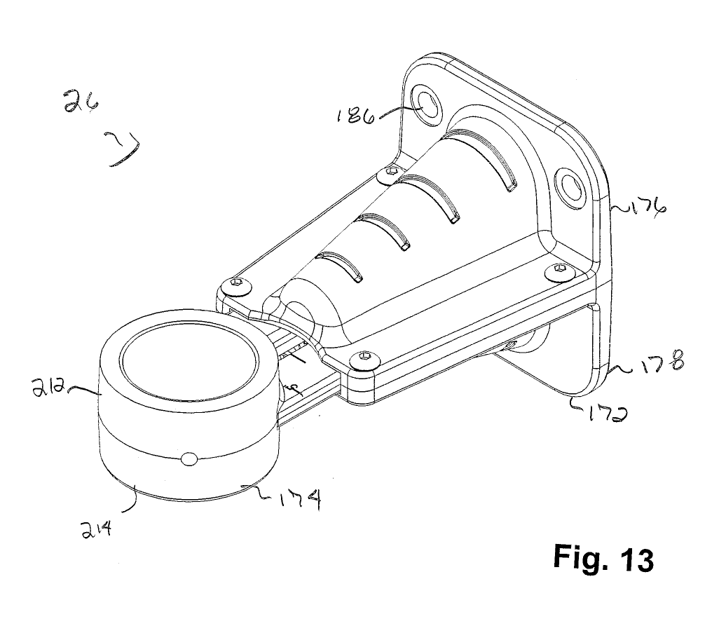

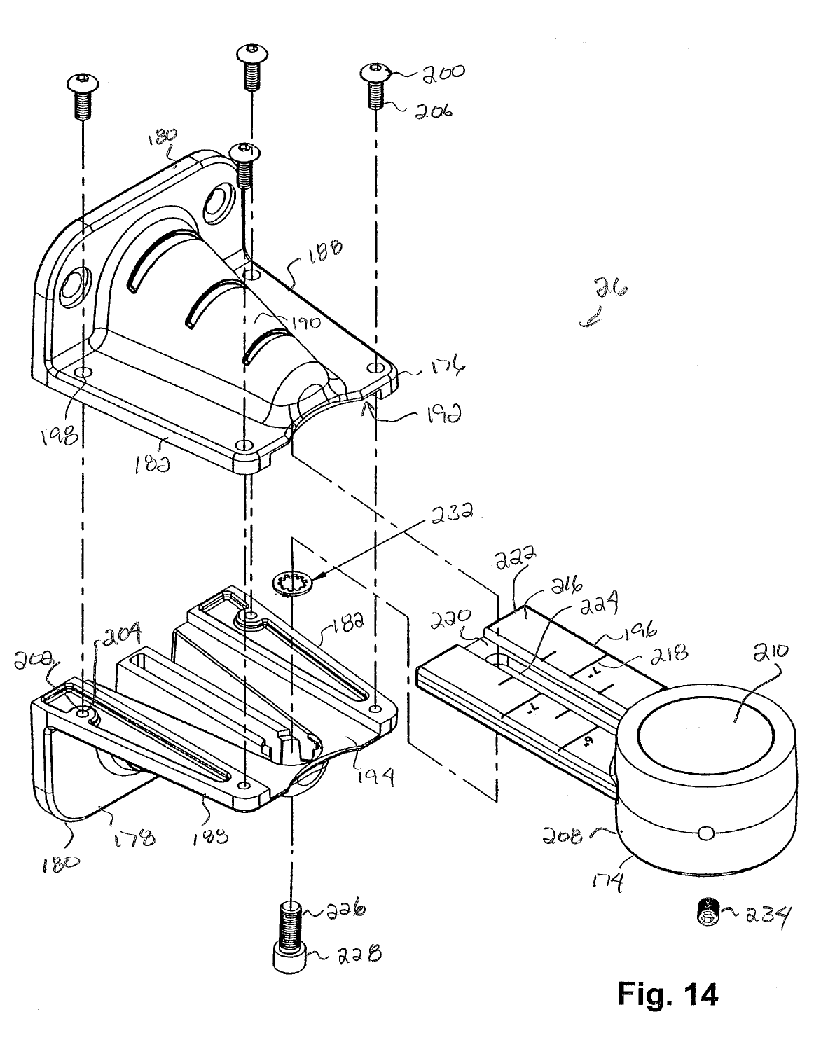

With regard to FIGS. 11-14, the mounting brackets 26 each include a pod assembly 172 and a bracket 174. The pod assembly 172 has upper and lower pod halves 176, 178, each of which includes a vertically extending flange segment 180 and a clamp segment 182 that extends horizontally from the flange segment 180 to a distal end 184. Each flange segment 180 has a pair of openings 186 through which fasteners (not shown) may be inserted to fixedly mount the mounting bracket 26 to a vehicle. The clamp segment 182 includes two rim portions 188 and a shell portion 190 disposed intermediate the rim portions 188. The distal end 184 has an opening 192 and the rim portions 188 define a channel 194 for slidably receiving the extension portion 196 of the bracket 174, as described in greater detail below. Each of the rim portions 188 of the upper pod half 176 has two openings 198 for receiving the shaft of a threaded fastener 200. Each of the rim portions 188 of the lower pod half 178 has two openings 202, each of which have a threaded inner surface 204 for threadably engaging the threaded fastener shaft 206, whereby the upper and lower pod halves 176, 178 are mounted together.

The bracket 174 has a receptacle portion 208 defining a vertical opening 210, and an extension portion 196 extending horizontally from the receptacle portion 208. The bracket 174 may be a monolithic, unitary device having upper and lower bracket portions 212, 214, or have separate upper and lower bracket portions that are fixedly mounted together by adhesive, a weld, or by similar means. The extension portion 196 of the upper bracket portion 212 has an upper surface 216 having index marks 218, such as a ruler, and a trough 220 extending from the receptacle portion 208 to a proximal end 222. The lower bracket portion 214 has a slot 224 extending from the receptacle portion 208 to a position intermediate the receptacle portion 208 and the proximal end 222.

The bracket extension portion 196 is inserted through the opening 192 in the distal end 184 of the pod assembly 172 into channel 194. A threaded shaft 226 of a set screw 228 is inserted through an opening 230 in the channel of the lower pod half 178, a lock washer 232, slot 224, and trough 220 and is threadably engaged inside a bore in the upper pod half 176. When the extension portion 196 has been inserted sufficiently that grab handle assembly 14 will be positioned at a predetermined distance from the vehicle, the set screw 228 is tightened to lock the extension portion 196 in position. The index marks 218 on the upper surface 216 of the extension portion 196 may be used to determine when the extension portion 196 has been properly positioned. The grab handle assembly 14 is inserted through the openings 210 at the mounting bracket 26 and set screws 234 in the side walls 236 of the receptacle portions 208 are tightened to lock the grab handle assembly 14 in position.

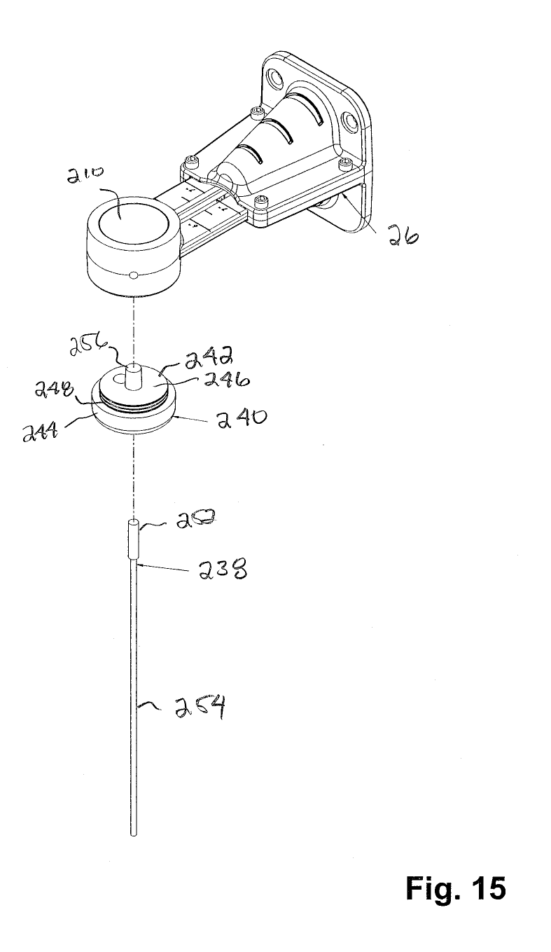

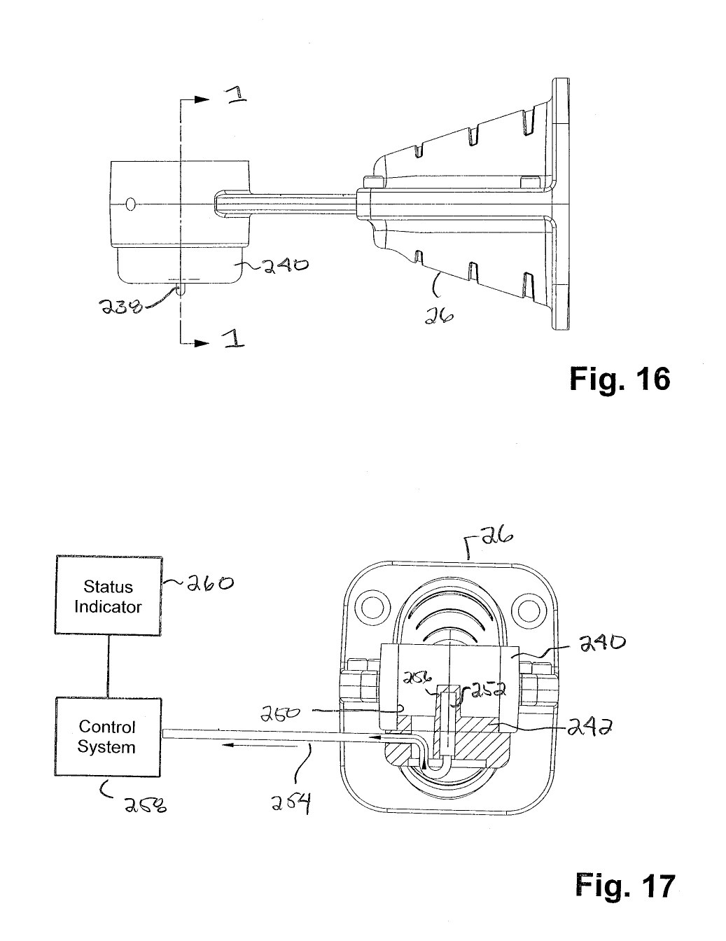

With reference to FIGS. 15-17, the light pole assembly 10 may include a support bracket 28 having a mounting bracket 26, a Hall Effect sensor device 238 and a sensor mount 240 mounting the Hall Effect sensor device 238 to the mounting bracket 26. The sensor mount 240 includes a platform segment 242 that extends upwardly from a base segment 244 to an upper surface 246. The sensor mount platform segment 242 is mounted within the receptacle portion opening 210 of the lower bracket half 214. In the example shown in FIGS. 15-17, the outer surface 248 of the platform segment 242 is mounted to the inner surface 250 of the receptacle portion opening 210 of the lower bracket half 214 by adhesive to permanently mount the sensor mount 240 to the mounting bracket 26. The bottom end 30 of the power line receptacle 22 is received in the receptacle portion opening 210 of the upper bracket half 212 and contacts the upper surface 246 of the platform segment 242 to support the extension member 12 when it is fully withdrawn in the stored position. The beveled surface of the bottom end 30 facilitates inserting the power line receptacle 22 into the receptacle portion opening 210 of the upper bracket half 212. When a support bracket 28 is utilized, the power line is inserted through one of the openings 34 in the sidewall 36.

The Hall Effect sensor device 238 includes a Hall Effect sensor 252 and a signal cable 254. The Hall Effect sensor 252 is mounted within a housing 256 that projects upwardly from the center of the upper surface 246 of the platform segment 242. When the extension member 12 is in the stored position, the housing 256 and the Hall Effect sensor 252 are positioned within the axial opening 32 of the power line receptacle 24 whereby the Hall Effect sensor 252 senses the presence of the power line receptacle 24 and transmits a signal to a control system 258. The bottom end 30 of the power line receptacle 24 may include a magnetic material to facilitate detection. The control system 258 operates a status indicator 260 with regard to the position of the extension member 12. For example, the control system 258 may operate one or more signal lights in the cab of the vehicle to provide visible indication that the extension member 12 is in the working position or the stored position. In addition, or alternatively, the control system 258 may operate an alarm to provide audible indication that the extension member 12 is not in the stored position.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A telescopic light pole system comprising:
a handle assembly including
a tubular grab handle longitudinally extending from a first end to a second end and having an inner surface defining a bore, and
at least one handle insert mounted on the grab handle, the handle insert being composed of a photoluminescent material;
at least one mounting bracket adapted to mount the handle assembly to a vehicle;
a tubular extension member extending through the grab handle bore from a first end to a second end;
a clamp collar assembly mounted to the handle assembly to selectively lock the extension member to the handle assembly;
a light fixture mounting member affixed to the first end of the extension member, the light fixture mounting member being adapted to mount a light fixture to the extension member; and
a power line receptacle affixed to the second end of the extension member.

2. The telescopic light pole system of claim 1 wherein the grab handle has an outer surface defining a plurality of longitudinally extending channels and one of the handle inserts is disposed within each of the channels.

3. The telescopic light pole system of claim 2 wherein each handle insert has an outer surface, the outer surface of the grab handle and the outer surface of each handle insert defining at least one longitudinally extending ridge.

4. The telescopic light pole system of claim 2 wherein:
each of the grab handle channels extends from the first end of the grab handle to the second end of the grab handle and includes a pair of recesses extending laterally from a central opening; and
each handle insert includes a pair of wings extending laterally from a central body, the handle insert central body being disposed within the grab handle channel and the handle insert wings being disposed within grab handle channel recesses.

5. The telescopic light pole system of claim 4 wherein the handle assembly also includes an end cap and the clamp collar assembly includes a collar base, the clamp collar assembly collar base being mounted to the first end of the grab handle and handle assembly end cap being mounted to the second end of the grab handle to lock the handle inserts within the grab handle channels.

6. The telescopic light pole system of claim 5 wherein the clamp collar assembly collar base has an end segment that is threadably connected to the grab handle inner surface and the handle assembly end cap has an end segment that is threadably connected to the grab handle inner surface.

7. The telescopic light pole system of claim 1 wherein the photoluminescent material of the handle insert has a glow life of at least twelve hours.

8. The telescopic light pole system of claim 1 wherein the light fixture mounting member includes:
a cylindrical shaft portion mounted to the extension member first end; and
a mounting portion extend orthogonally from the shaft portion to a front face adapted for engaging a light fixture.

9. The telescopic light pole system of claim 8 wherein the light fixture mounting member shaft portion has an end segment that is threadably connected to an inner surface of the extension member.

10. The telescopic light pole system of claim 8 wherein the light fixture mounting member mounting portion includes a back wall and a tubular sleeve extending from the back wall, the tubular sleeve defining a bore that is substantially coaxial with an opening extending through the back wall, the sleeve bore and the back wall opening being adapted to receive a bolt for mounting a light fixture to the mounting portion.

11. The telescopic light pole system of claim 1 wherein the power line receptacle has a substantially cylindrical sidewall having outer and inner surfaces, the power line receptacle defining a bore extending longitudinally from a bottom end and at least one opening extending laterally from the sidewall outer surface to the sidewall inner surface.

12. The telescopic light pole system of claim 11 wherein the power line receptacle bottom end is beveled.

13. The telescopic light pole system of claim 11 further comprising a support bracket including:
a mounting bracket having
a pod assembly adapted for mounting to the vehicle, and
a bracket extending from the pod assembly, the bracket having a receptacle for receiving the power line receptacle bottom end; and
a power line receptacle sensor mounted to the bracket for sensing when the power line receptacle bottom end has been received within the bracket receptacle.

14. The telescopic light pole system of claim 13 wherein the power line receptacle sensor is a Hall Effect sensor.

15. The telescopic light pole system of claim 14 wherein the support bracket also includes a sensor mount mounting the Hall Effect sensor to the mounting bracket.

16. The telescopic light pole system of claim 15 wherein:
the bracket receptacle defines an opening extending from an upper surface to a lower surface; and
the sensor mount includes
a base segment mounted to the bracket receptacle, and
a platform segment extending upwardly from the base segment into a lower end portion of the bracket receptacle opening, the platform segment having an upper surface to support the power line receptacle bottom end.

17. The telescopic light pole system of claim 16 wherein:
the sensor mount platform segment includes a housing projecting upwardly from the upper surface, the housing being positioned within the power line receptacle bore when the power line receptacle bottom end is supported on the sensor mount platform segment upper surface; and
the Hall Effect sensor is disposed within the housing of the sensor mount platform segment.

18. The telescopic light pole system of claim 17 wherein the power line receptacle bottom end includes a magnetic material.

19. The telescopic light pole system of claim 13 further comprising a pole status system comprising:
a pole status indicator; and
a controller in communication with the power line receptacle sensor and the status indicator.

20. The telescopic light pole system of claim 1 wherein the mounting bracket comprises:
a pod assembly including
a flange segment adapted to mount to the vehicle, and
a clamp segment extending from the flange segment to a distal end, the clamp segment defining a channel extending from an opening in the distal end;
a bracket including
an extension portion having distal and proximal ends, a proximal end segment of the extension portion being slidably disposed within the clamp segment channel, and
a receptacle portion disposed at the extension portion distal end, the receptacle portion defining an opening for receiving the handle assembly; and
a bracket locking device to lock the bracket extension portion to the pod assembly.

21. The telescopic light pole system of claim 20 wherein the bracket extension portion includes an upper surface having index marks.

22. The telescopic light pole system of claim 20 wherein the bracket extension portion includes:
an upper segment defining a trough extending from the bracket receptacle portion to the proximal end; and
a lower segment defining a slot extending from the bracket receptacle portion to a position intermediate the bracket receptacle portion and the proximal end.

23. The telescopic light pole system of claim 22 wherein the bracket locking device is a set screw having a threaded shaft and a head, the set screw shaft extending through an opening in a lower portion of the clamp segment, the slot in the bracket extension portion lower segment, and the trough in the bracket extension portion upper segment, and threadably engaging a bore in an upper portion of the clamp segment.

24. A telescopic light pole system comprising:
a handle assembly including
a tubular grab handle longitudinally extending from a first end to a second end and having an inner surface defining a bore, and
at least one handle insert mounted on the grab handle, the handle insert being composed of a photoluminescent material;
at least one mounting bracket adapted to mount the handle assembly to a vehicle;
a tubular extension member extending through the grab handle bore from a first end to a second end;
a clamp collar assembly mounted to the handle assembly to selectively lock the extension member to the handle assembly;
a light fixture mounting member affixed to the first end of the extension member, the light fixture mounting member being adapted to mount a light fixture to the extension member;
a power line receptacle affixed to the second end of the extension member, the power line receptacle having a bottom end portion; and
a support bracket including:
a receptacle for receiving the power line receptacle bottom end portion, and
a power line receptacle sensor for sensing when the power line receptacle bottom end has been received within the support bracket receptacle.

25. The telescopic light pole system of claim 24 wherein the photoluminescent material of the handle insert has a glow life of at least twelve hours.

26. The telescopic light pole system of claim 24 wherein the power line receptacle sensor is a Hall Effect sensor device.

27. A telescopic light pole system comprising:
a handle assembly including a tubular grab handle longitudinally extending from a first end to a second end and having an inner surface defining a bore;
at least one mounting bracket adapted to mount the handle assembly to a vehicle;
a tubular extension member extending through the grab handle bore from a first end to a second end;
a clamp collar assembly mounted to the handle assembly to selectively lock the extension member to the handle assembly;
a light fixture mounting member affixed to the first end of the extension member, the light fixture mounting member being adapted to mount a light fixture to the extension member;
a power line receptacle affixed to the second end of the extension member, the power line receptacle having a bottom end portion; and
a support bracket including:
a receptacle for receiving the power line receptacle bottom end portion, and
a power line receptacle sensor for sensing when the power line receptacle bottom end has been received within the support bracket receptacle.

28. The telescopic light pole system of claim 27 wherein the power line receptacle sensor is a Hall Effect sensor.

29. The telescopic light pole system of claim 28 wherein the power line receptacle has a substantially cylindrical sidewall defining a bore extending longitudinally from a bottom end and the Hall Effect sensor is disposed within the power line receptacle bore when the support bracket receptacle receives the power line receptacle.

30. The telescopic light pole system of claim 29 further comprising a pole status system comprising:
a pole status indicator; and
a controller in communication with the Hall Effect sensor and the status indicator.
